(19) United States
(12) Patent Application Publication
(10) Pub. No.: US 2004/0047973 A1
(43) Pub. Date: Mar. 11, 2004

(54) Method of improving safety and quality of cooking oils

(76) Inventors: Yves Bourhis, Westmont, IL (US); James T.C. Yuan, Naperville, IL (US); Michael F. Smith, Danville, CA (US)

Correspondence Address: Air Liquide, Linda K. Russell, Suite 1800, 2700 Post Oak Blvd., Houston, TX, 77056, US

(21) Appl. No.: 10/643,360

(22) Filed: Aug. 19, 2003

Related U.S. Application Data
(60) Provisional application No. 60/409,149, filed on Sep. 9, 2002.

(51) Int. Cl. A23D 7/00

(52) U.S. Cl. 426/601

(57) ABSTRACT

A method for improving the quality and safety of a cooking oil while extending the working life of the cooking oil includes the steps of applying a non-reactive gas or a non-reactive gas mixture to a cooking oil, with a food residue therein, during the working lifetime of the cooking oil. Thereby, reactions, which degrade the cooking oil, may be inhibited. Furthermore, the formation of acrylamide within or on foods cooking in the oil may be inhibited. An optional step of pre-treating and/or packaging a food product before it is cooked in the cooking oil, whereby oxygen is removed and/or excluded from the food product and/or the ambient of the food product, may enhance the results that can be obtained by the invention. Preferably, the optional pre-treatment and/or packaging step is applied to the food product before it is cooked in the cooking oil. Consequently, the quality of a cooking oil can be maintained and its working life can also be extended. Moreover, the safety risk due to acrylamide formation within or on fried foods can be minimized.

### BACKGROUND OF THE INVENTION

1. Field of the Invention

Frying has long been one of preferred methods of cooking, and more than 50% of food consumed in U.S. restaurants is fried. For example, although catfish is tasty baked or broiled, most prefer it battered and fried, with fried hush puppies on the side. Some people will not eat okra any way but fried, then there are also croquettes, fried tomatoes, fried chicken, french fries, and a variety of fritters and breads. Cooking oil plays an important role in frying process, as the quality of the cooking oil throughout the frying process determines the quality of finished fried foods.

Some major factors causing cooking oil degradation during cooking are lipolysis and oxidation. Lipolysis results during frying at least partly due to the relatively large amount of moisture introduced into the cooking oil from food, and the relatively high temperatures at which cooking oil is maintained. Lipolysis is hydrolysis of ester bonds in lipids. It occurs either by enzyme action or by the combination of heat and moisture, resulting in the liberation of free fatty acids. The release of free fatty acids by hydrolysis is responsible for rancid flavor development in cooking oil. These same free fatty acids developed in the course of frying are susceptible to oxidation, which produces off-odors.

In lipid oxidation, the free fatty acids developed in the oil from lipolysis react with molecular oxygen in the presence of heat to form free radicals. During the cooking process air, which contains oxygen present in a concentration of about 20.9%, is constantly added through food into the cooking oil. The combination of high temperature and agitation of the foods as they cook in the oil causes the lipid oxidation to occur rapidly. The rapid production of free fatty acids into free radicals causes the quality of the cooking oil to quickly deteriorate and its working life to quickly expire.

Along with the presence of oxygen, the free radicals in the cooking oil are believed to contribute to acrylamide formation in fried foods. Recently, acrylamide has become a major concern to the public health related to cooking oil and fried foods. It is a genotoxic carcinogen that may form in high concentrations when carbohydrate-rich foods are fried in cooking oil. Carbohydrate-rich foods include rice, potatoes, and cereals. The U.S. Environmental Protection Agency classifies acrylamide as a “medium hazard probable human carcinogen.” It is linked to gene mutations leading to cancer, including breast and uterine cancer, and tumors in the adrenal glands and internal lining of the scrotum. It is also known to produce neurotoxic effects in humans and many experimental animals. Although the precise mechanism, of acrylamide formation is not clear at this time, it appears to be related to the presence of free radicals, oxygen, and heat within the cooking oil.

2. Description of the Related Art

There has been much work done to improve the quality of cooking oil and extend its working life. However, most of this work has focused on improving the quality of the cooking oil during the production stage and the storage stage. For example, inhibition of oxidation effects during the process, manufacture, and storage of beverages and cooking oil using noble gas sparging and inerting was mentioned by Spencer (WO 93/19626). Similarly, use has been made of inert gases in the production, bottling, and storage of beverages, specifically to improve the keeping properties of alcoholic beverages produced by fermentation (GB 1331533). Cheng mentions the use of a non-condensable inert gas, such as nitrogen, to deodorize cooking oils as the final processing step in the production of edible oils and fat products. (U.S. Pat. No. 5,241,092). Application of trisyl silica has also been used to improve the stability and the quality of cooking oil refining. (“Stability and Quality Aspects in Edible Oil Refining With Trisyl Silica”, Griselli, F and Morton, R. B.: Fett Wess Technology, Volume 92, 1990, 445-446.) Oxygen absorbers have been added into the headspace and/or into the oil phase of oil to prevent lipid autoxidation. (“Improvement of quality maintenance of edible oils using free oxygen absorber”, Ichikawa et al.: Journal of the Japan Oil Chemists' Society, Volume 45, 1996, 875-877.)

Even though improving the quality of cooking oil during the production and storage stages is important, maintaining oil quality and slowing down its degradation during its working life are just as important. Few technologies have addressed this concern. Filtration technology was used to improve the quality of recycled cooking oil by lowering its free fatty acid content (U.S. Pat. No. 6,325,941). Munson and Others (U.S. Pat. No. 5,597,600) treated cooking oil with magnesium silicate and at least one alkali material, such as calcium hydroxide, to reduce the free fatty acid content of cooking oil and to extend the working life of cooking oil. A method of stabilization of cooking oils by addition of natural antioxidants from sources, such as spices, herbs, teas, oils, seeds, cereals, cocoa shell, grains, fruits, vegetables, enzymes, and proteins, has also been described. (“Stabilization of Edible Oils With Natural Oxidants”, Yanishlieva, Nedyalka V. and Marinova, Emma M.: European Journal of Science and Technology, Volume 103, 2001, 752-767.) Similarly, Nager (WO 90/00015) teaches that antioxidants such as BHA and BHT can be used to reduce oxidation and rancidity of cooking oil during the heating process. Nager also applied the capsule idea for delivering the antioxidant to the cooking oil. Nevertheless, use of a filtration system to remove free fatty acid may not be effective due to the size of free fatty acid. Furthermore, adding chemicals into cooking oil at high temperatures brings up the concern of potential carcinogenic derivatives.

The work done still fails to describe a method to address the root causes of cooking oil degradation during the cooking process. The root causes of degradation are lipolysis, oxidation and to some extent acrylamide formation.

Those skilled in the art will recognize that there is a need to inhibit lipolysis in cooking oil during its working lifetime.

Those skilled in the art will also recognize that there is a need to inhibit oxidation in cooking oil without the use of chemicals that may form carcinogenic materials.

Those skilled in the art will further recognize that there is a need to improve the safety of cooking oil by inhibiting the formation of acrylamide in carbohydrate rich foods that are cooked in the oil.

Those skilled in the art will further recognize that there is also a need to improve the quality of cooking oil during the cooking process.

Those skilled in the art will further recognize that there is a need to extend the working life of cooking oil.

### BRIEF SUMMARY OF THE INVENTION

Thus it is a primary object to provide a method for improving the quality, safety, and working lifetime of cooking oil. The method includes the following step. A non-reactive gas or non-reactive gas mixture is applied to cooking oil having a food residue therein.

### BRIEF DESCRIPTION OF THE SEVERAL VIEWS OF THE DRAWINGS

FIG. 1, is a graphical display of the free fatty acid content of cooking oil treated with various gases according to the invention versus a control.

FIG. 2, is a graphical display of the spectrophotometric color index of cooking oil treated with various gases according to the invention versus a control.

FIG. 3, is a graphical display of the free fatty acid content of cooking oil treated with various gases according to the invention, at various temperatures.

FIG. 4, is a graphical display of the spectrophotometric color index of cooking oil treated with various gases according to the invention, at various temperatures.

### DETAILED DESCRIPTION OF THE INVENTION

In accordance with this invention, we have discovered a method of improving the quality, safety, and working lifetime of a cooking oil, having a food residue therein from a cooking process by applying a non-reactive gas to said cooking oil. This invention may also utilize a mixture of non-reactive gases instead of a single gas. Furthermore, the invention may also be useful with various types of cooking oils including, but not limited to, vegetable oil, shortening, olestra, seed oil, chemically modified edible oils, physically modified edible oils, and olive oil. Preferably, in each embodiment of the invention, the cooking oil may be maintained within a temperature range sufficient to fry food, which is usually at least about 300° F. The phrase, having a food residue therein, means that the cooking oil has been uses at least once for cooking as opposed to a cooking oil that has never been used for cooking.

A non-reactive gas is one that has a tendency to not participate in reactions. They were chosen because of their inert nature. They also work well for this invention because they are very useful in separation and/or stripping methods. A non-limiting list of non-reactive gases includes, nitrogen, argon, carbon dioxide, krypton, xenon, neon and mixtures thereof.

The non-reactive gas may be applied to the cooking oil by sparging. The non-reactive gas may also be applied to the cooking oil through a membrane. Moreover, any method known to those skilled in the art that would be suitable to achieve the effect of the present invention may also be used to apply the gas to the cooking oil. Preferably, in any embodiment of the invention described or that may be derived from the description, the application of the non-reactive gas to the cooking oil is substantially continuous. The phrase “substantially continuous” as used herein means that the gas is introduced into the cooking oil in either an uninterruptedly manner or introduced in constant intervals, such as by alternating periods of introduction and zero flow.

The non-reactive gas is applied in order to displace the substances in the cooking oil that react with it to form degradation byproducts. We believe that the non-reactive gas displaces these substances first by acting as a stripping means. After displacing the substances from the cooking oil, the non-reactive gas will then occupy the volume once occupied by these substances in the cooking oil. Those substances displaced include, but are not limited to, at least one of moisture, oxygen, free radicals, dissolved organic compounds, and undesirable volatile compounds.

The flowrate of the non-reactive gas applied may be chosen based upon the amount of foodstuff loaded in the cooking oil, and it may vary in range from a few ml/min to several liters/min. The amount of gas applied is preferably related to, either the amount of foodstuff loaded in the cooking oil, or the regularity with which the cooking oil is used. Thus, a relatively large amount of foodstuff loaded in the cooking oil may require a relatively large amount of gas to displace these substances from the cooking oil. On the other hand, a relatively small amount of foodstuff loaded in the cooking may require a relatively small amount of gas. Similarly, when relatively frequent use is made of the cooking oil, more non-reactive gas may be required to displace the substances. Preferably, a flowrate is selected such that the amount of non-reactive gas applied to the cooking oil will minimize the presence of the substances to be displaced.

We have identified that the displacement of at least some moisture from the cooking oil may be important in obtaining the objectives of the invention. During the cooking process, moisture is continuously introduced into the cooking oil, by foodstuffs cooking within it. This moisture may react with the cooking oil resulting in the formation of free fatty acids through a reaction called lipolysis. Lipolysis is the hydrolysis of the ester bonds in lipids. This reaction of the lipid, for example, with moisture (H₂O) results in the release of a free fatty acid, such as hexanoic acid CH₃(CH₂)₄COOH, if the lipid above is lipolysized. The free fatty acids that are released are highly reactive and highly susceptible to oxidation. The moisture content and/or the temperature of the cooking oil affect the degree of hydrolysis. By displacing at least some of this moisture, lipolysis may be inhibited or minimized.

We have also identified that the displacement of at least some of the oxygen from the cooking oil may be important in obtaining the objectives of this invention. The cooking oil is highly susceptible to autoxidation, which can yield products such as hydroperoxides or other such free radicals, which are highly susceptible to further oxidation. Furthermore, the free fatty acids, products of lipolysis, within the cooking oil are also highly susceptible to oxidation. Lipid oxidation occurs in the cooking oil due to the high temperature and presence of oxygen. The oxidation of the free fatty acids in the cooking oil occurs due to their highly reactive nature, the high temperature, and the presence of oxygen in the cooking oil. By displacing at least some of the oxygen in the cooking oil, these oxidation reactions may be inhibited or minimized.

We also believe that the displacement of at least some of the free radicals formed as a result of oxidation of free fatty acids, may be also important in obtaining the objective of this invention. Without being bound to any particular theory, we believe that acrylamide formation occurs within the fried foods as a result of a reaction between free radicals and oxygen in the cooking oil. Acrylamide is considered by many to be a major health concern to the public. It has also been linked to gene mutations that lead to cancer, and it has produced neurotoxic effects in humans and many experimental animals. If at least some free radicals are displaced along with some oxygen, it may be possible to inhibit acrylamide formation in fried foods.

The methods of this invention are applicable during any portion of the working life of the cooking oil. The phrase “working life” as used herein encompasses the time from which use of the cooking oil for cooking begins until the time the cooking oil is discarded. Cooks usually discard the cooking oil because they believe that its quality is unsatisfactory. Some characteristics that indicate that the quality may be unsatisfactory include excessive color, excessive darkness, malodorousness, and unpleasant flavors.

If preferred, the non-reactive gas may be applied to the cooking oil after a cooking process is complete, and the cooking oil is idle or currently not in use for cooking a foodstuff, such as when it is allowed to sit to cool or sit overnight. The non-reactive gas may be applied to the cooking oil at that time either in constant intervals or uninterruptedly. The non-reactive gas may also be applied for a period of time, after the cooking process is completed, such as for the shift or for the day, which is sufficient to purge the cooking oil. During such an application, the application may be stopped until the cooking oil is used again. Application of the non-reactive gas to the cooking oil may also be continued even when the cooking oil is idle, because it remains susceptible to oxidative reactions. For example, oxygen from the air may continue to diffuse into the cooking oil through surface contact. This oxygen needs to be displaced in order to inhibit oxidation of the cooking oil when not in use. Furthermore, the cooking oil normally remains at a high temperature, even when it is idle; thereby providing a prime environment for oxidative reactions to continue to deteriorate the quality of the cooking oil. In this case, a headspace, of non-reactive gas over the cooking oil, may be optionally maintained in order to prevent re-entry of the substances displaced, by any other means known in the art to be suitable for that purpose.

If preferred, the non-reactive gas may also be applied to the cooking oil before and after it has been used for cooking a foodstuff.

We have also discovered that an optional step of pre-treating and/or packaging foodstuffs before they are cooked in the cooking oil may enhance the results obtained by the invention. The pre-treating step may be utilized to remove at least some oxygen from the foodstuff and/or from the surrounding environment of the foodstuff. Preferably, no oil is introduced to the foodstuff before the removal of at least some of the oxygen. The packaging step may be utilized to create a barrier to prevent oxygen from reentering the foodstuffs once it is removed, or to prevent additional oxygen from entering the food whether or not the optional pre-treating step is utilized. In combination, the pre-treating and the packaging steps may relatively greatly decrease the amount of oxygen introduced into the cooking oil.

Once foodstuffs are prepared, oxygen from the air diffuses into them, and this contacts the cooking oil once they are introduced into it. By first removing and then excluding oxygen from the foodstuffs, a relatively lesser amount of oxygen enters into the cooking oil. The oxygen in foodstuffs causes quality degradation problems to the foodstuff due to its oxidative nature. Therefore, removal of at least some oxygen from the foodstuff and exclusion of oxygen from entry or re-entry into the foodstuff may greatly inhibit the amount of the oxygen that enters the cooking oil. Preferably, the steps of the invention are carried out prior to cooking the foodstuffs in the cooking oil.

In one embodiment of the invention, the step of pre-treating the foodstuffs may be performed by applying a vacuum. This optional pre-treating step may include placing a foodstuff in a container or the like. Then a vacuum may be applied to the foodstuff and/or to the ambient of the foodstuff in order to draw the air present out of the foodstuff and/or container.

In another embodiment of the invention, the step of pre-treating the foodstuffs may be performed by using a modified atmosphere in order to exclude oxygen, or to lessen the amount of oxygen therein. This optional step may include placing a foodstuff in a container or the like. Then a modified atmosphere is applied to the foodstuff and/or the ambient of the foodstuff to displace oxygen therefrom. The modified atmosphere includes, but is not limited to, nitrogen, carbon dioxide, argon, krypton, xenon, neon and mixtures thereof.

In another embodiment of the invention, the step of pre-treating the foodstuffs may be performed by using both the modified atmosphere and vacuum treatments as described above. This may be accomplished by applying a vacuum to the foodstuff and/or the ambient of the foodstuff to remove air present in the foodstuff or container prior to applying the modified atmosphere to the foodstuff and/or the ambient of the foodstuff in order to remove and exclude oxygen.

The optional pre-treatment step described above may be followed by an optional step of packaging said foodstuff such that re-entry of oxygen may be inhibited. This may be accomplished by hermetically sealing the container, or by any other means known to those in the art as suitable to obtain the effect intended by the present invention. The container or the like may be stored at about ambient temperature or below. It is also within the scope of this invention to utilize the packaging step without utilizing the pre-treatment step.

Surprisingly, we have discovered that the invention may significantly inhibit the reaction of lipolysis within the cooking oil, such that its quality is maintained and the working life of the cooking oil is extended. When the cooking oil is more or less continuously used to cook foodstuffs for a period of time, moisture is continuously introduced to the cooking oil by foodstuff during the cooking process. The non-reactive gas applied, will displace moisture, a substance introduced into the cooking oil through foods that are cooked within, and which fuels lipolysis. Therefore, displacement of moisture in the cooking oil at some time during its working life may be highly advantageous. Displacing this moisture inhibits lipolysis and thus formation of free fatty acids.

To our surprise, we have also discovered that the invention may also significantly inhibit oxidative reactions within the cooking oil, such that the quality of the oil can be maintained and the working life may be extended. The non-reactive gas applied will displace oxygen. The free fatty acids, which are products of lipolysis, are susceptible to oxidation, which may result in the formation of free radicals that can degrade the cooking oil and cause a more rapid expiration of its working life. Furthermore, auto-oxidative deterioration of the cooking oil can be inhibited or minimized as well.

Surprisingly, application of the non-reactive gas to the cooking oil resulted in significantly less darkening in its appearance as compared to cooking oil without the application of the non-reactive gas. Darkening of the cooking oil is usually a strong indication that degradation byproducts may have proliferated in the oil during the cooking process. Darkening of the cooking oil may also be a strong indication that its quality has decreased such that the working life of the cooking oil has expired, and it should be discarded. Minimal darkening of the cooking oil, when non-reactive gas is applied, may indicate that the substances may have been displaced from the cooking oil, such that the rate of formation of degradation byproducts, as well as any other byproducts formed that may result in darkening of the cooking oil, has been relatively greatly slowed.

We also believe that the invention can inhibit or minimize acrylamide formation in fried foods. We, and others skilled in the art, believe that acrylamide formation may be related to the presence of free radicals in the cooking oil that are formed as a result of the oxidation of free fatty acid in the cooking oil. We believe that the oxygen and the free radicals react to form acrylamide, which may be a human carcinogen that may remain on or within the fried foods that are consumed by people. It is possible, that by displacing free radicals and oxygen, the reactions leading to acrylamide formation in the foods cooked within the oil may be inhibited or minimized. This could greatly reduce this major health risk related to fried foods.

Unexpectedly, we observed that applying the non-reactive gas to the cooking oil may also increase convection within the oil during cooking. Therefore, less heat energy may be required to cook the food with about the same efficiency. Usually, the non-reactive gas is at a temperature below that of the cooking oil, so when it is applied to the cooking oil, the overall temperature is lowered. When sparging is used as the means of applying the gas to the oil, the bubbles of gas rise up within the liquid oil and increase convection in the cooking vat. As a result, greater heat transfer occurs within the cooking vat, and the food will cook just as well (for example at a temperature of about 300° F. or higher) as it would at the higher temperature of usually at least and without the application of the gas. We believe that over time this may result in the use of less energy, in the form of heat applied to the oil, in order to achieve the same results without the application of the non-reactive gas.

### EXAMPLES

We measured the change in free fatty acid content and the change in the spectrophotometric color index over time in the cooking oil under simulated process conditions. We delivered moist air along with non-reactive gas to deep fryers, and in the case of the control only moist air was delivered to a deep fryer. The temperature of the deep fryer was maintained at the normal temperature for cooking foods, which is usually 340° F. Observations were made of the changes in the cooking oil when a non-reactive gas was applied, in comparison to the changes in the cooking oil when a non-reactive gas was not applied. The above changes were observed over a period of 6 days. Each of carbon dioxide, nitrogen, and argon were used.

Each fryer unit was equipped with a sparging system to sparge inert gas and/or moist air. Moist air was produced by sparging air through a stainless steel vessel containing water. Then, the resultant moist air was introduced to each fryer unit through a sparger in order to simulate the introduction of moisture, which is usually introduced into the cooking oil as part of the food, under real cooking conditions. Three of the four fryer units had an additional sparger in order to introduce the non-reactive gas carbon dioxide, nitrogen, and argon. The control was the fryer unit without the additional sparger.

The fryer units were filled with 3 liters of vegetable oil, turned on simultaneously, and then the cooking temperature was set for each unit at 340° F. Moist air was introduced to all the fryers once they reached the target temperature, with the flow rate adjusted to simulate the real introduction rate of moisture from a foodstuff. Then the non-reactive gas was introduced into the respective frying units, with the flowrates set slightly higher than that of the moist air.

The cooking process was continued for approximately 7 hours per day for a duration of six working days. At the end of each day, the moist air was shut down, the fryers were turned off, and the inert gas flow rate was reduced to a minimal level until the next morning. Samples of about 200 ml were collected the following morning before the fryers were turned on. Fresh vegetable oil was also added to each fryer to compensate the sampling loss so that the total volume of the cooking oil was kept constant.

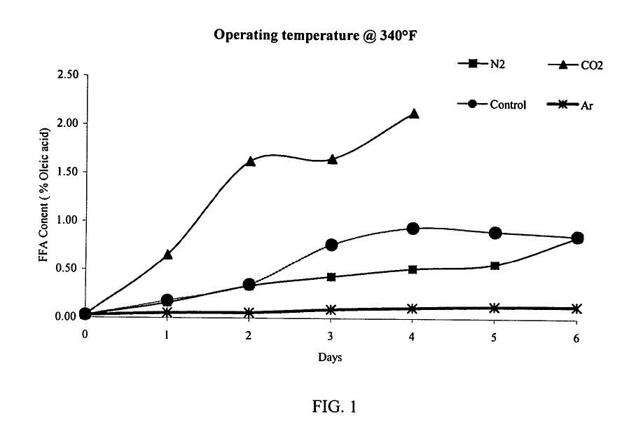

In FIG. 1, the change in free fatty acid content for cooking oil with application of a non-reactive gas in comparison to the control is graphically displayed. The control shows a relatively high increase over time in free fatty acid content. Although we did observe some change in the free fatty acid content of the cooking oil(s) to which a non-reactive gas was applied, FIG. 1 demonstrates that the change is relatively greatly slowed. Therefore, we believe that the non-reactive gas displaced at least some of the moisture and oxygen from the cooking oil.

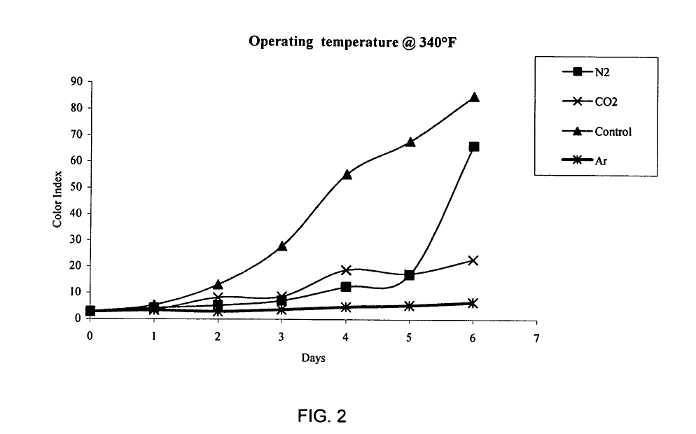

In FIG. 2, the change in spectrophotometric color index for cooking oil with application of a non-reactive gas in comparison to the control is graphically displayed. The control shows a fairly high change over time in the color index. Although, we did observe a relatively small change in the spectrophotometric color index for the cooking oil(s) to which a non-reactive gas was applied, FIG. 2 demonstrates that this change is relatively greatly slowed. Therefore, we believe that the non-reactive gas displaced at least some of the substances in the cooking oil, during the cooking process, which react with cooking oil to thereby darken it.

As seen in Table I, application of the gases resulted in about a 23% to about a 99% less of a change in the spectrophotometric color index in comparison to the control.

TABLE I
Spectrophotometric index of cooking oils over time

| Day(s) | Control | N₂ | CO₂ | Ar |
|---|---|---|---|---|
| 0 | 2.825 | 2.825 | 2.825 | 2.825 |
| 1 | 5.345 | 4.177 | 3.559 | 4.177 |
| 2 | 13.161 | 5.217 | 8.239 | 2.994 |
| 3 | 27.945 | 7.087 | 8.701 | 2.967 |
| 4 | 55.306 | 12.464 | 18.876 | 4.355 |
| 5 | 67.851 | 17.071 | 17.500 | 3.192 |
| 6 | 85.012 | 66.083 | 22.932 | 3.016 |

We also evaluated the effect of temperature on the working life of the cooking oil. Three containers of cooking were heated to 186° F., 340° F., and 378° F. respectively. The argon and moist air flowrates were kept at 79 mL/min and 60 mL/min, respectively.

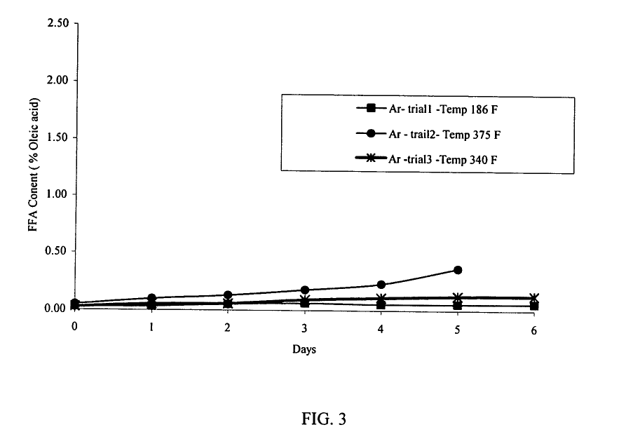

In FIG. 3, the changes in free fatty acid content for the cooking oil at the above temperatures to which argon was applied are compared. The results show that the greatest increase in free fatty acid content is observed at the highest temperature and that the least increase in free fatty acid is observed at the lowest temperature. Still, a comparison of the results obtained at the normal temperature for cooking of 340° F. versus an elevated temperature of 378° F. shows that the application of the gas, slows the production of free fatty acids.

As seen in Table II, this invention can achieve about a 60% less of an in increase in the change in the free fatty acid content with the application of argon at the lower temperature of 340° F. in comparison to the elevated temperature of 378° F.

TABLE II
Free Fatty Acid Content Over Time

| Argon, 340° F. | | | | Argon, 378° F. | | | |
|---|---|---|---|---|---|---|---|
| Day | S1 | S2 | Average | Day | S1 | S2 | Average |
| 0 | 0.030 | 0.025 | 0.027 | 0 | 0.049 | 0.049 | 0.049 |
| 1 | 0.050 | 0.054 | 0.052 | 1 | 0.099 | 0.097 | 0.098 |
| 2 | 0.059 | 0.054 | 0.057 | 2 | 0.139 | 0.122 | 0.130 |
| 3 | 0.089 | 0.096 | 0.092 | 3 | 0.173 | 0.185 | 0.179 |
| 4 | 0.099 | 0.124 | 0.112 | 4 | 0.223 | 0.243 | 0.233 |
| 5 | 0.122 | 0.129 | 0.125 | 5 | 0.346 | 0.389 | 0.367 |
| 6 | 0.136 | 0.119 | 0.127 | 6 | 0.302 | 0.118 | 0.210 |

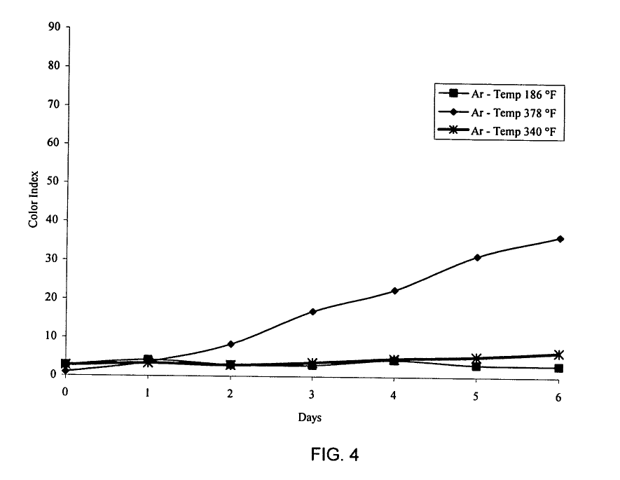

In FIG. 4, the spectrophotometric color indexes of the cooking oil at the above temperatures, to which argon was applied, are compared. The results show that while a relatively larger increase in the change in the spectrophotometric color index is observed at the highest temperature, the least increase in spectrophotometric color index is observed at the lowest temperature. Still, a comparison of the results obtained at the normal temperature for cooking of 340° F. versus an elevated temperature of 378° F. shows that the application of the gas, slows the increase in a spectrophotometric index of the oil.

As seen in Table III, about 85% less of an increase in the change of the spectrophotometric color index with the application of argon at the lower temperature of 340° F., in comparison to the elevated temperature of 378° F.

TABLE III
Spectrophotometric Index Over Time

| Day | Argon, 186° F. | Argon, 340° F. | Argon, 378° F. |
|---|---|---|---|
| 0 | 2.825 | 2.766 | 1.010 |
| 1 | 4.177 | 3.365 | 3.644 |
| 2 | 2.994 | 2.890 | 8.319 |
| 3 | 2.967 | 3.645 | 16.969 |
| 4 | 4.355 | 4.729 | 22.595 |
| 5 | 3.192 | 5.337 | 31.422 |
| 6 | 3.016 | 6.524 | 36.493 |

Having described the present invention it will now be apparent to one of ordinary skill in the art that many changes and modifications may be made without departing from the specification and the scope of the present invention.

We claim:

1. A method of improving the quality, safety, and working lifetime of a cooking oil having a food residue therein from a cooking process, comprising the step of:
applying a non-reactive gas or non-reactive gas mixture to said cooking oil.

2. The method according to claim 1, further comprising the step of:
a) maintaining a temperature of said cooking oil in a range sufficient to cook a foodstuff.

3. The method according to claim 2, wherein the temperature is maintained in a range of at least about 300° F.

4. The method according to claim 1, wherein the non-reactive gas or non-reactive gas mixture is selected from the group consisting of nitrogen, argon, carbon dioxide, krypton, xenon, and neon.

5. The method according to claim 1, wherein the non-reactive gas or non-reactive gas mixture is applied to said cooking oil by sparging.

6. The method according to claim 1, wherein the non-reactive gas or non-reactive gas mixture is applied to said cooking oil through a membrane.

7. The method according to claim 1, wherein application of the non-reactive gas or non-reactive gas mixtures is substantially continuous.

8. The method according to claim 7, wherein said non-reactive gas or non-reactive gas mixture is applied to said cooking oil either at constant intervals or in a constant motion.

9. The method according to claim 1, wherein substances reactable with said cooking oil are displaced, thereby inhibiting formation of degradation byproducts.

10. The method according to claim 9, wherein the substances displaced comprise any one or more of oxygen, free radicals, dissolve organic compounds, undesirable volatile compounds, and moisture.

11. The method according to claim 9, wherein reactions resulting in formation of degradation byproducts within said cooking oil are minimized or inhibited.

12. The method according to claim 11, wherein the reactions comprise at least one of lipolysis, oxidation, and acrylamide formation

13. The method according to claim 5, wherein a flowrate of the non-reactive gas or non-reactive gas mixture applied is selected based upon an amount of foodstuff loaded in said cooking oil.

14. The method according to claim 5, further comprising the step of:
a) maintaining a temperature of the cooking oil in a range sufficient to cook a foodstuff, wherein the sparging of the cooking oil increases convection currents within the cooking oil such that less heat is required to cook the foodstuff in comparison to cooking the foodstuff in the cooking oil at the temperature without the sparging of the oil.

15. The method according to claim 1, wherein visible darkening of said cooking oil during cooking of a foodstuff is inhibited in comparison to when a foodstuff is cooked in said cooking oil at the temperature but without the application of the non-reactive gas or non-reactive gas mixture.

16. The method according to claim 2, wherein an increase in a photometric color index of said cooking oil during cooking of a foodstuff is inhibited in comparison to when a foodstuff is cooked in said cooking oil at the temperature but without the application of the non-reactive gas or non-reactive gas mixture.

17. The method according to claim 2, wherein an increase in a free fatty acid content of the cooking oil during cooking of a foodstuff is inhibited in comparison to when the foodstuff is cooked in said cooking oil at the temperature but without the application of the non-reactive gas or non-reactive gas mixture.

18. The method according to claim 2, wherein increases in a free fatty acid content and photometric color index of the cooking oil during cooking of a foodstuff is inhibited in comparison to when a foodstuff is cooked in the cooking oil at the temperature but without the application of the non-reactive gas or non-reactive gas mixture.

19. The method according to claim 2, further comprising the steps of:
a) providing a foodstuff to be fried in said cooking oil;
b) removing at least some oxygen from said foodstuff; and
c) hermetically sealing said foodstuff to inhibit introduction of oxygen into said foodstuff, said sealing step occurring after said removing step.

20. The method according to claim 18, wherein at least some oxygen is removed by applying either a vacuum or a modified atmosphere gas stream to said foodstuff

21. The method according to claim 18, wherein the modified atmosphere is selected from the group consisting of nitrogen, carbon dioxide, argon, krypton, xenon, neon, and mixtures thereof.

22. The method according to claim 19, whereby introduction of oxygen into said cooking oil is inhibited in comparison to when said foodstuff is introduced into the cooking oil without removing at least some oxygen and hermetically sealing said foodstuff.

23. The method according to claim 1, wherein an oxygen concentration of the cooking oil is lowered by application of the non-reactive gas or non-reactive gas mixture, thereby inhibiting oxidation of the cooking oil.

24. The method according to claim 1, whereby production of free fatty acids in said cooking oil during a cooking process is inhibited by application of the non-reactive gas or non-reactive gas mixture.

25. The method according to claim 1, wherein a moisture content of the cooking oil is reduced by application of the non-reactive gas or non-reactive gas mixture, thereby inhibiting lipolysis of the cooking oil.
